(19) United States
(12) Patent Application Publication
(10) Pub. No.: US 2026/0092725 A1
(43) Pub. Date: Apr. 2, 2026

(54) CRYOGENIC COOLING SYSTEM WITH A RESONANT EXPANDER

(71) Applicant: R7 Instruments, Inc., Somerville, MA (US)

(72) Inventors: Jacob Adams, Somerville, MA (US); Carl Bunge, Somerville, MA (US)

(21) Appl. No.: 19/344,208

(22) Filed: Sep. 29, 2025

Related U.S. Application Data
(60) Provisional application No. 63/700,990, filed on Sep. 30, 2024.

(51) Int. Cl. F25B 9/06; F25B 9/14

(52) U.S. Cl. CPC F25B 9/06; F25B 9/14; F25B 11/02; F25B 31/023

(57) ABSTRACT

Disclosed is a resonant expander usable in a cryogenic cooling system. The resonant expander may comprise an expansion chamber with a reciprocating piston. The piston divides the expansion chamber into a warm and a cold displacement volume. Passive acoustic valves allow high-pressure fluid into the cold displacement volume and allow low-pressure fluid out of the cold displacement volume. The low-pressure fluid may cool at exiting the resonant expander. The piston free from solid contact with an external mechanism, thereby not requiring sliding seals. Piston and displacement volumes form a mechanically resonant system at the operating frequency of the resonant expander, ensuring correct acoustic valve actuation. Electromagnetic system having a permanent magnet assembly fixed to the piston and a coil at the expansion chamber with a control system, is disclosed. Disclosed is a cryogenic cooling system having the resonant expander, a compressor and recuperative heat exchanger providing low temperature fluid.

### CROSS-REFERENCE TO RELATED APPLICATIONS

This application claims the benefit of U.S. Provisional Application No. 63/700,990, filed Sep. 30, 2024, which is incorporated herein by reference in its entirety.

### FIELD OF TECHNOLOGY

This disclosed subject matter relates to a cryogenic cooling system and a resonant expander for providing a fluid at low temperatures.

### BACKGROUND

Two well known techniques have been suggested for use in achieving low temperature or cryogenic operation, particularly using helium as a fluid, for example. One approach is referred to as a Collins Cycle (or alternatively referred to as a multi-stage Claude Cycle and/or Brayton Cycle) and the second approach is referred to as the Stirling cycle.

The Collins Cycle is used to provide refrigeration or liquefaction at “liquid-helium’ temperatures. The Claude Cycle is used to provide refrigeration or liquefaction at higher temperatures using fluids such as nitrogen. Cryogenic refrigeration systems have evolved through various thermodynamic approaches, with expansion-based cooling representing a fundamental principle across multiple cycle configurations. Traditional expansion mechanisms have employed both positive displacement and turbomachinery approaches, each presenting distinct scaling and efficiency characteristics.

The broader field of cryogenic refrigeration encompasses various expansion technologies including turboexpanders, reciprocating expanders, and throttling devices. Each technology presents unique advantages and limitations regarding efficiency, scalability, and operational complexity. Turbine expanders excel in large-scale applications but face challenges in miniaturization due to aerodynamic scaling effects and bearing complexity at small sizes.

Reciprocating expansion devices offer potential advantages in smaller-scale applications but traditionally require complex valve actuation systems and sealing mechanisms. The integration of passive or semi-passive valve systems represents an area of ongoing development, particularly for applications requiring reduced complexity and improved reliability. For example, the Collins Cycle technique is described as being effective when used for relatively large-scale production of low temperature helium, for example, it has been found to be difficult to scale down the apparatus size when a smaller system is required and still retain the low temperature effectiveness thereof. One of the limiting components in the traditional Collins cycle is the expander. The alternative to piston expanders are turbine expanders which are well known in the art. However, turbine expanders also face difficulty scaling to smaller size.

Resonant mechanical systems have found application in various fluid machinery applications, offering potential benefits in terms of efficiency and reduced mechanical complexity. The application of resonant principles to expansion devices represents an emerging area of development in cryogenic refrigeration technology.

A challenge with piston expanders known in the art is the use of active intake and exhaust valves to the expansion chamber. These valves usually require external actuation by a push rod or electromagnetic actuation or pneumatic actuation. The opening and closing of the intake and exhaust valves must be precisely timed with the piston motion to ensure efficient operation of the expander. In addition, the electromagnetic actuation or pneumatic actuation requires additional control circuitry, and thus additional electrical power. Moreover, the mechanisms that provide electromagnetic or pneumatic actuation may be sources of heat that reduce the efficiency of any refrigeration device that would utilize a resonator system to provide refrigeration. What is needed is a system that operates with passive valves or semi passive valves that do not require external actuation when operating in steady state.

Another challenge with the piston expanders known in the art is a rubbing seal between the piston and cylinder so that the working fluid does not either leak out of the machine nor blow past the piston. This seal requires periodic maintenance and may introduce friction to the piston motion.

Another challenge with piston expanders known in the art is the periodic return means for the piston motion which is typically a flywheel and crankshaft assembly. This periodic return means is necessary to allow for continuous operation of the piston expander. The periodic return means in existing techniques is bulky, cumbersome, and requires a shaft to extend between the piston within the expansion chamber and a flywheel outside of the expansion chamber. This physical connection between the piston and flywheel requires a sliding seal such that the working fluid does not leak out of the expansion chamber.

Passive valving, known as check valves or reed check valves, are commonly used in compressors and are well known in the art. However the use of passive valves in expanders is seldom taught.

Another approach used in the prior art to achieve low temperature is referred to as the Stirling cycle. The Stirling cycle uses heat exchange passage called a thermal regenerator. Those skilled in the art will recognize that the term thermal regenerator refers to bi-directional heat exchangers which often have been selected for relatively small scale refrigeration systems due to their mechanical simplicity. This is in contrast to the unidirectional heat exchangers (recuperator type heat exchangers) that are used in the Collins cycle as previously described. The thermal regenerator used in the Stirling cycle suffers from low performance at liquid helium temperatures, and hence Collins cycle which uses a recuperator is more efficient at liquid helium temperatures.

Prior art has described free piston resonant expansion compressor concepts with various control mechanisms.

Hirano teaches of a reciprocation type expansion compressor that uses a single piston in resonance to drive a heat pump cycle. The piston is driven electromagnetically and compresses the working fluid on one end while the other end of the piston the working fluid is expanding. The compression end uses passive check valves. The expansion end uses actively controlled valves. There is a control system that senses the piston position and actuates the expansion valves.

### BRIEF SUMMARY

The disclosed subject matter provides a resonant expander for use in a cryogenic cooling system. The resonant expander is comprised of an expansion chamber with a piston adapted for periodic movement within said expansion chamber, the piston being free from solid contact with a mechanism that is external to the expansion chamber. The piston divides the expansion chamber into a warm displacement volume and cold displacement volume and said piston has a range of motion extending between said cold displacement volume disposed at one end of the expansion chamber and said warm displacement volume disposed at another end of the expansion chamber. There is an inlet fluidic connection from a first fluid state to the resonant expander and an outlet fluidic connection from a second fluid state to the resonant expander. An inlet acoustic valve fluidically couples said inlet fluidic connection said cold displacement volume. Similarly, there is an outlet acoustic valve that fluidically couples said outlet fluidic connection to said cold displacement volume. The inlet acoustic valves have an equilibrium position which is open and a negative flow resistance thereby allowing the acoustic valves to actuate passively, and/or semi-passively. The piston, and/or fluid within the warm displacement volume, and/or fluid within the cold displacement volume create a resonant system substantially at the operating frequency of the resonant expander. The periodic movement of the piston is maintained by coupling and decoupling the fluid from the first fluidic connection and the second fluidic connection via the inlet acoustic valve and outlet acoustic valve, respectively, and the cooled fluid is output from the second fluidic connection.

The resonant expander is used in a cryogenic cooling system for providing a low temperature fluid. The cooling system includes a compressor, a recuperative heat exchanger disposed in fluid communication with the compressor, and a resonant expander with acoustic valves disposed in fluid communication with the heat exchanger.

The disclosed subject matter also provides a resonant expander for use in a cryogenic cooling system that utilizes an electromagnetic system. The electromagnetic system may act as an electromagnetic driver and/or electromagnetic damper. The resonant expander is comprised of an expansion chamber with a piston adapted for periodic movement within said expansion chamber, the piston being free from solid contact with a mechanism that is external to the expansion chamber. The piston divides the expansion chamber into a warm displacement volume and cold displacement volume and said piston has a range of motion extending between said cold displacement volume disposed at one end of the expansion chamber and said warm displacement volume disposed at another end of the expansion chamber. There is an inlet fluidic connection from a first fluid state to the resonant expander and an outlet fluidic connection from a second fluid state to the resonant expander. An inlet acoustic valve fluidically couples said inlet fluidic connection said cold displacement volume. Similarly, there is an outlet acoustic valve that fluidically couples said outlet fluidic connection to said cold displacement volume. The inlet acoustic valves have an equilibrium position which is open and a negative flow resistance thereby allowing the acoustic valves to actuate passively, and/or semi-passively. Said electromagnetic system is comprised of a permanent magnet fixed to said piston to form a piston-magnet assembly, a stator assembly fixed to said expansion chamber and a controller to control operation of said piston motion. The piston-magnet assembly, and/or fluid within the warm displacement volume, and/or fluid within the cold displacement volume, and/or stator assembly create a resonant system substantially at the operating frequency of the resonant expander. The periodic movement of the piston is maintained by coupling and decoupling the fluid from the first fluidic connection and the second fluidic connection via the inlet acoustic valve and outlet acoustic valve, respectively, and the cooled fluid is output from the second fluidic connection. The periodic movement of the piston-magnet assembly is also maintained by the electromagnetic system.

### BRIEF DESCRIPTION OF THE DRAWINGS

To easily identify the discussion of any particular element or act, the most significant digit or digits in a reference number refer to the figure number in which that element is first introduced.

FIG. 1 illustrates an embodiment of an exemplary resonant expander according to the disclosed subject matter.

FIG. 2 shows a schematic representation, with portions thereof shown in cross section, of a resonant expander according to the disclosed subject matter.

FIG. 3 shows another embodiment of a resonant expander according to the disclosed subject matter.

FIG. 4 shows a further embodiment of a resonant expander according to the disclosed subject matter.

FIG. 5 shows another embodiment of an exemplary resonant expander where the dissipation mechanism includes an exemplary throttling valve according to the disclosed subject matter

FIG. 6 shows an exemplary spring balancer system for reducing exported vibrations of an exemplary resonant expander of the prior examples according to the disclosed subject matter.

FIG. 7 shows another embodiment of a resonant expander according to the disclosed subject matter.

FIG. 8 illustrates an embodiment of an exemplary cryogenic cooling system using an exemplary resonant expander as described according to the disclosed subject matter.

FIG. 9 shows an exemplary depiction of the pressure oscillations with respect to time in a resonant expander as described according to the disclosed subject matter.

FIG. 10 is an exemplary depiction of an acoustic valve operating principle as described according to the disclosed subject matter.

FIG. 11 illustrates an aspect of the subject matter in accordance with one embodiment.

### DETAILED DESCRIPTION

The following describes a resonant expander configured to operate with passive valves or semi passive valves that do not require external actuation when operating in steady state, and thereby do not introduce any extraneous sources of heat or increase complexity of system utilizing the resonant expander as described herein.

Moreover, It is another objective of the present disclosed subject matter to operate without an external periodic return means by use of a floating piston or free piston. Instead of an external periodic return means, a resonant system is formed between the moving piston mass and the fluid springs within the expansion chamber. Solid member from outside the expansion chamber.

In an embodiment we have describe that unlike the prior art the following describes examples of an expander where the piston is in communication with a fluid spring to form a resonant system. As well as systems that use a floating piston without external connections to a flywheel or supporting shaft. The following describes the use of passive expander valves in conjunction with a resonant system.

In an example, disclosed resonant expander operates through passive acoustic valve control, thereby eliminating the need for active valve actuation systems. The acoustic valves may exhibit negative flow resistance characteristics, providing greater conductance during pressure increases than during pressure decreases. This can enable automatic timing of intake and exhaust cycles in synchronization with piston motion and pressure oscillations.

Additionally, the system may incorporate electromagnetic driving and damping capabilities through magnet assembly and stator coil configurations, allowing for control of resonant amplitude and frequency. Energy dissipation mechanisms through check valve systems can provide additional control over system dynamics and efficiency optimization.

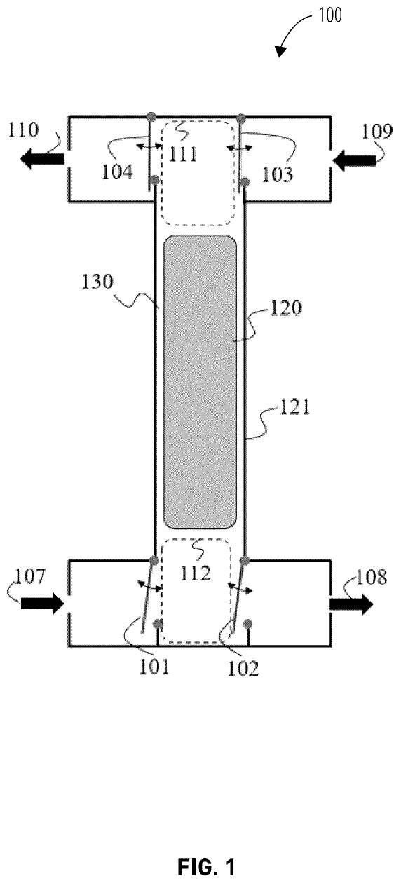

FIG. 1 illustrates an embodiment of an exemplary resonant expander according to the disclosed subject matter. The working fluid in FIGS. 1-11 may be a gas or mixture of several gases such as air, nitrogen, oxygen, carbon dioxide, helium, hydrogen, nitrogen, etc. or the working fluid may be a liquid, or the working fluid may be a multi-phase mixture of a gas and/or a liquid and/or a solid.

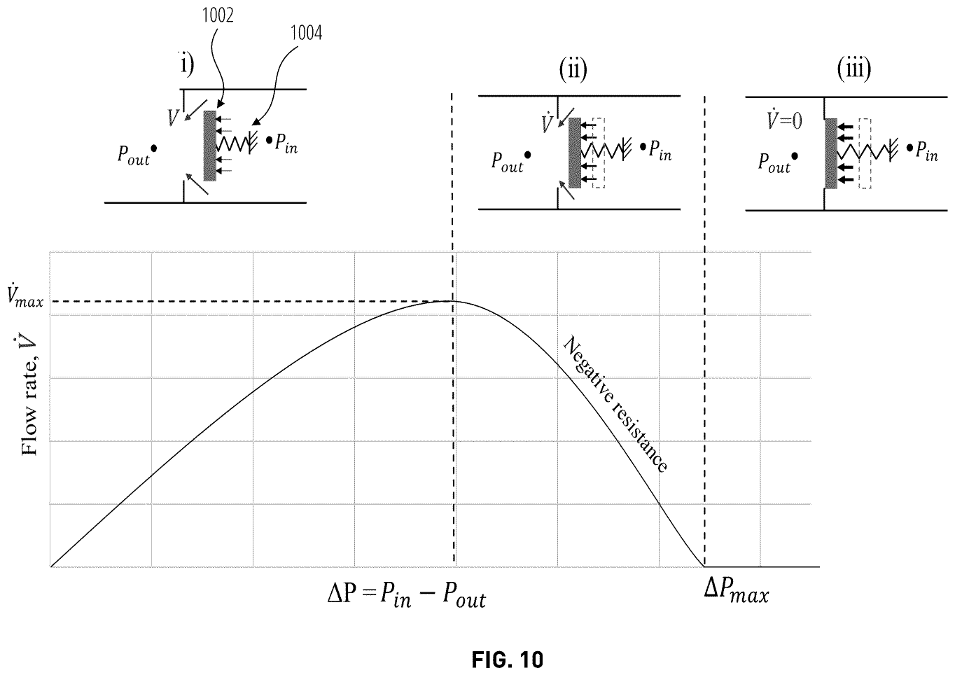

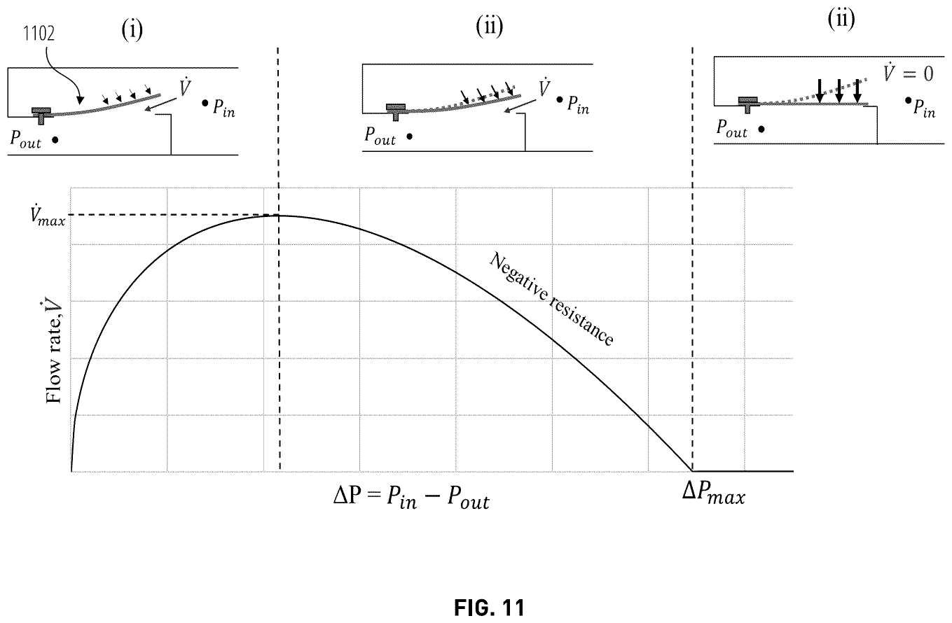

The resonant expander 100 includes a piston 120 that floats with the fluid in a closed expansion chamber 121 to form cold and warm displacement volumes 112 and 111, at opposite ends thereof. The working fluid discussed above is the fluid used in the respective displacement volumes of the resonant expander 100. At the cold displacement volume 112 end of the expansion chamber 121, high pressure fluid is admitted through an inlet acoustic valve 101 and low pressure fluid is exhausted through a similar outlet acoustic valve 102. Acoustic valves 101 and 102 are described in greater detail below and may exhibit a negative flow characteristic, such as that described with reference to FIGS. 10-11, or a different negative flow characteristic. The acoustic valves 101 and 102 may, for example, exhibit a negative flow resistance characteristic, providing greater conductance during pressure increases than during pressure decreases, which enables automatic timing of intake and exhaust cycles in synchronization with piston motion and pressure oscillations. In various embodiments, the acoustic valves may have a negative flow characteristic and may be configured to oscillate passively and/or semi-passively. The inlet acoustic valve 101 may, for example, be a first valve that fluidically couples a first fluid source (not shown in this example) to the cold displacement volume via the fluidic connection 107, while the outlet acoustic valve 102 may be a second valve that fluidically couples a second fluid source to the cold displacement volume. The acoustic valves 101 and 102 may have an equilibrium position (described more with reference to a later example) which is open, and exhibit the negative flow characteristic that enables automatic timing of intake and exhaust cycles. The acoustic valves are configured to oscillate passively and/or semi-passively, eliminating the need for external actuation systems during steady-state operation.

The piston 120 is a low-compliance (e.g., substantially incompressible) member sized and shaped for receipt within the expansion chamber 121. In an exemplary embodiment the piston may have a diameter that is on the order of 1 inch to 10 inches. There is a gap 130 between the piston and expansion chamber. In an exemplary embodiment this gap 130 may be 0.005 inches, or the like. In this example, the gap 130 does not require a rubbing seal. The piston provides a substantially direct transfer of energy between the displacement volume 111 and 112. In an exemplary embodiment, the piston 120 may be a hollow cylinder capped on either end and may be fabricated from a metal like steel or stainless steel or a solid lightweight composite such as micarta, carbon fiber, or the like.

Furthermore, the piston 120 may be a fluid piston. In this case, the fluid within the expansion chamber that is contained between the displacement volumes 111 and 112 acts as a fluid piston that is transferring energy between the two displacement volumes 111 and 112.

Those skilled in the art will recognize that the axial length of the piston 120 may be selected to sufficiently isolate the cold displacement volume 112 from the warm displacement volume 111 without excessively increasing the mass of the piston 120. In an exemplary embodiment, the piston 120 may have a length between 10 to 30 inches and/or on the order of 10s of inches.

There may be periodic flow of fluid through the gap 130 from cold displacement volume 112 to warm displacement volume 111 driven by the pressure difference between the two volumes. In some embodiments, the gap 130 is made sufficiently narrow and the piston 120 made sufficiently long such that this periodic flow does not reduce the efficiency of the resonant expander nor does it thermally short the warm to cold displacement volumes. This periodic gap flow may, for example, assist in keeping the piston from contacting or rubbing on the expansion chamber walls, having an effect similar to a gas bearing. The periodic gap flow may function to potentially eliminate mechanical contact and reduce friction while maintaining pressure separation between the displacement volumes 111 and 112. This configuration may enhance system reliability and reduce wear.

In accordance with the principles of the present disclosed subject matter, the piston 120 and the fluid displacement volumes 111 and 112 may be configured so that the mass of the piston 120 and the force constant of the fluid displacement volumes provide a combination that is mechanically resonant at a desired operating frequency of the resonant expander 100. The resonant expander 100 may include the fluid displacement volumes 111 and 112 and the moving piston 120, the fluidic connections 107-110, inlet valves 101, 103, and outlet valves 102 and 104, and other components.

In various embodiments, the fluidic connections 107, 108, 109, and 110 of the resonant expander 100 are at different fluid states. The fluid state refers to the thermodynamic properties of the fluid, for example the thermodynamic properties may include temperature, pressure, enthalpy, density, viscosity, entropy, etc. In embodiments incorporating additional fluidic connections, a third fluid state may be coupled to the warm displacement volume 111 by a third fluidic connection 109, and a fourth fluid state may be coupled to the warm displacement volume by a fourth fluidic connection 110. These additional fluidic connections can enable enhanced energy dissipation mechanisms through, for example, check valve configurations. The resonant expander 100 can accommodate various working fluids and may be scaled for different capacity requirements while maintaining resonant operational principles.

The mathematical definition of the resonance condition is

$$f = ( \frac{1}{2 π} ) \sqrt{\frac{K}{M}}$$

Where:
f is the resonant frequency in Hz
K is the spring force constant in Newtons per meter
M is the effective mass of the piston (including any mass moving with the piston) in kilograms

In an exemplary embodiment, the resonant expander has a resonant frequency that is about 50 Hz+/−2 Hz. The resonant frequency can be any value, typically on the order of tens to hundreds of Hz. In accordance with the mathematical definition, the fluid springs 111 and 112 may be made stiffer to increase the resonant frequency or the piston mass may be made smaller. Higher resonant frequencies may be preferable to increase the power output of the resonant expander. Various resonant frequencies may be useful in different applications of the disclosed subject matter.

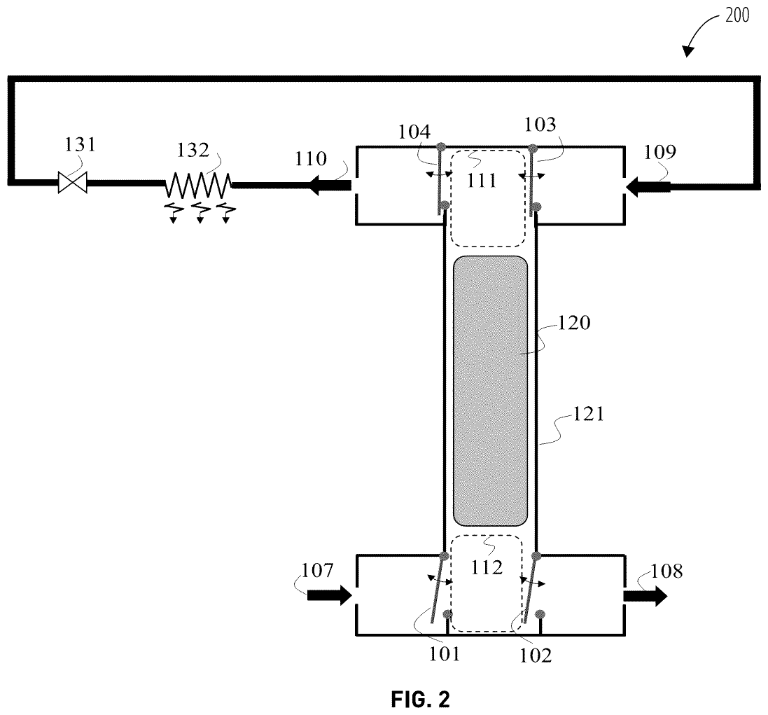

The energy stored in this resonant expander 100 may include the kinetic energy of the moving piston 120, the stored pressure energy in cold displacement volume 112, and the stored pressure energy in warm displacement volume 111. Each of the warm displacement volume 111 and the cold displacement volume 112 may act as fluid springs, whereby the fluid compresses and decompresses as does a spring. As per the definition of resonance, the energy that is added to the resonant system (i.e., resonant expander 100) per cycle is less than the total energy stored in the resonant system. The flow of working fluid through the acoustic valves 101 and 102 that act on the cold displacement volume 112 add energy to the resonant expander 100. The added energy is stored in the resonant expander 100 as piston 120 motion and in the fluid springs in the warm displacement volume 111 and cold displacement volume 112. An objective of the disclosed subject matter is to expand and cool the working fluid as it exits fluidic connection 108. To achieve this cooling effect, a net flow of energy away from the cold displacement volume 112 is provided. In other words, the energy that is added by fluid expansion at cold displacement volume 112 is removed from the resonant expander 100 preferably at a location of higher temperature. The removal of energy from the resonant expander 100 may be performed with a dissipation mechanism. Exemplary dissipation mechanisms may be any one of several embodiments as described in FIGS. 2-7. Note dissipation mechanism are not limited to the several embodiments of a dissipation mechanism shown and described with reference to FIGS. 2-7, which are provided merely as non-limiting dissipation mechanism examples.

In the FIG. 1 embodiment, the warm displacement volume 111 end of the expansion chamber 121 may have an inlet valve 103 and an outlet valve 104. In this embodiment, the valves 103 and 104 are one-way check valves or one-way reed valves. A check valve only allows fluid to flow in one direction. For example, low pressure fluid is admitted through the inlet check valve 103 and the high pressure fluid is exhausted through the outlet check valve 104. The flow of working fluid through the check valves 103 and 104 that act on the warm displacement volume 112 remove energy from the resonant system. Therefore, there is a net flow of energy from the cold displacement volume 111 to the warm displacement volume 112 that affects an isentropic expansion process, and hence cooling of, the working fluid as it leaves fluidic connection 108. In various embodiments, the valves disposed at the inlet port 109 (also referred to as fluidic connection 109) and outlet port 110 (also referred to as fluidic connection 110) of the warm displacement volume 112 may be one-way check valves that automatically respond to pressure oscillations. The check valves 103 and 104 may be configured to allow fluid to enter the warm displacement volume 112 at a third pressure and third temperature through the inlet port, and to allow fluid to exit the warm displacement volume 112 at a fourth pressure and fourth temperature through the outlet port or fluidic connection 110.

In FIG. 1, the working fluid enters the resonant expander from first fluid state via the inlet fluidic connection 107. The working fluid exits the resonant expander at a second fluid state via the outlet fluidic connection 108. Alternatively, the working fluid enters from a third fluid state via an inlet fluidic connection 109. The working fluid also exits at a fourth fluid state via an outlet fluidic connection 110.

These fluidic connections at 107, 108, 109, and 110 may be headers, plenums, tubes, or the like. For most applications and designs, the working fluid is expanding from fluidic connection 107 to fluidic connection 108. In this case, the second pressure at 108 is less than the first pressure at 107. Furthermore, the second temperature at 108 is less than the first temperature at 107. Similarly, for most applications and designs the working fluid may be compressing from fluidic connection 109 to fluidic connection 110. In this case, the fourth pressure at 110 may be greater than the third pressure at 109. Furthermore, the fourth temperature at 110 may be greater than the third temperature at 109.

In an alternative embodiment, the piston 120 may comprise a plurality of pistons internal to the expansion chamber 121, where each respective piston of the plurality of pistons is adapted for periodic movement within the expansion chamber 121. Each of the plurality of pistons may be adapted for movement within the expansion chamber 121 while maintaining the resonant system characteristics.

FIG. 2 is a schematic representation, with portions thereof shown in cross section, of a resonant expander according to the disclosed subject matter. In this example, the resonant expander is operable to circulate compressed fluid from, for example, the warm displacement volume 111.

In the embodiment of FIG. 2, a resonant expander is shown in which fluid is circulated from fluidic connection 110 to fluidic connection 109 through an ambient heat exchanger 132 and a flow control valve 131. The thick solid lines represent tubes or fluidic channels for the working fluid to flow. In the FIG. 2 embodiment, the energy of expansion provided by the resonant expander is ultimately dissipated as heat in the ambient heat exchanger 132. Note that the fluidic circuit between fluidic connection 110 and 109 is a closed dissipation system in this embodiment. This closed dissipation system prevents a continuous, net leakage of the working fluid from warm displacement volume 111 to cold displacement volume 112.

In more detail, the working fluid is circulated from fluidic connection 110 to fluidic connection 109 by the oscillating pressure in the warm displacement volume 111. The pressure in the warm displacement volume 111 is oscillating in time as the piston 120 periodically moves back and forth in the expansion chamber 121 at the resonant frequency of the system. When the oscillating pressure in the warm displacement volume 111 becomes larger than the pressure at fluidic connection 110, check valve 104 opens allowing fluid to leave the warm displacement volume 111. When the oscillating pressure in the warm displacement volume 111 is lower than the pressure at fluidic connection 109, the check valve 103 opens allowing fluid to enter the warm displacement volume 111. The fluid pressure at fluidic connection 110 is greater than the fluid pressure at fluidic connection 109. Therefore, the fluid is effectively pressurized by the pressure oscillations in the warm displacement volume 111, and the subsequent heat of compression is removed by heat exchanger 132. The flow control valve 131 controls the rate at which fluid is circulated between fluidic connection 110 to fluidic connection 109, and hence, controls the rate of dissipation from the resonant expander. It should be appreciated that flow control valve 131 can be replaced with, for example, another expander to drive a separate refrigeration cycle or recollect the work as electricity in a generator.

The motion of the piston 120 within the range of motion as described above with reference to FIGS. 1-2, may be driven electromagnetically and/or damped electromagnetically.

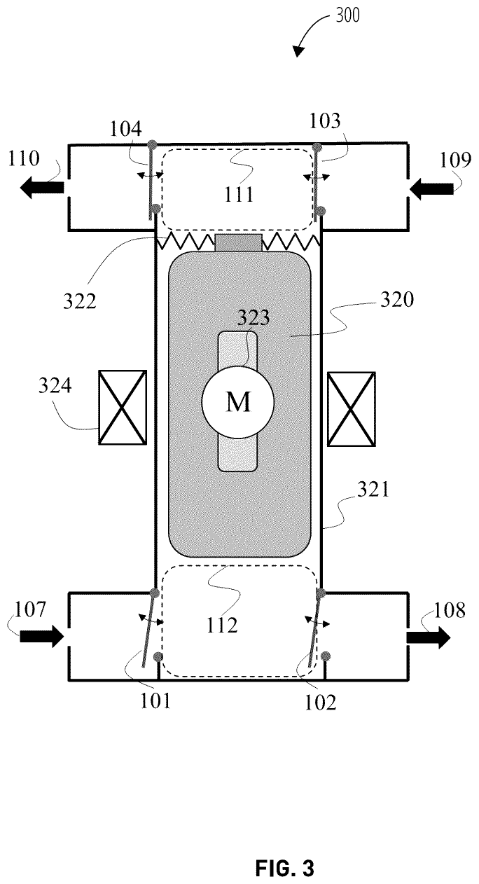

FIG. 3 shows another embodiment of a resonant expander.

The motion of the piston 320 within the range of motion may be driven electromagnetically and/or damped electromagnetically, wherein a magnet assembly 323 can be rigidly fixed to the piston and a stator coil 324 may be positioned to inductively add energy to or dissipate energy from the magnet-piston assembly. In certain implementations, the resonant system 300 may further comprise a computer operable to control the position of the magnet-piston assembly, providing precise control over the electromagnetic driving and/or electromagnetic damping of the resonant system 300. The computer may be configured to sense piston position and apply driving forces dependent on the piston position to ensure optimal valve actuation and system performance. In an example, the same resonant relationship may be accomplished using a mechanical spring substituted or in addition to the fluid springs formed by warm displacement volume 111 and cold displacement volume 112. The displacement volumes 111 and 112 may also be referred to as fluid springs.

In this embodiment, a magnet assembly 323 can be rigidly fixed to the piston 320 and a stator coil 324 can be positioned to inductively add energy to or dissipate energy from a magnet-piston assembly formed from the magnet assembly 323, stator coil 324, and the piston 320. The piston 320 may, for example, be configured in much the same manner as the piston 120 and may be formed from similar materials, but in the exemplary resonant system 300 the piston 320 is affected by electromagnetic forces.

The magnet assembly 323 may, for example, be a permanent magnet. For example, the magnet assembly 323 may be fixed to the piston 320 and the electromagnetic stator coil 324 that at the exterior of the expansion chamber 321 may be used to control the position of the piston 320.

In certain implementations, the position of the piston 320 may further comprise a computer operable to control the position of the piston 320 by providing precise control over the electromagnetic driving and/or electromagnetic damping of the stator coil 324 and the magnet assembly 323. The computer may be configured to sense piston position and apply driving forces dependent on the piston position to ensure optimal valve actuation and resonant system 300 performance.

FIG. 3 also shows an exemplary flexure bearing 322 that is fixed to the piston 320 and the expansion chamber 321. This flexure bearing prevents or minimizes contact between the piston 320 and the expansion chamber 321. Flexure bearings 322 may be constructed in the Oxford style or with other spring-like assemblies. The flexure bearing 322, in this example, allows the piston 320 to move in the axial direction (i.e., up and down from 111 and 112) while restricting movement in the radial direction. The electromagnetic assembly (i.e., the magnet assembly 323 and stator coil 324) may also be used to center the piston 320 within the expansion chamber 321 to prevent or minimize rubbing of the piston 320 with the expansion chamber 321. This technique is known as a magnetic bearing. Other methods can be employed using the electromagnetic assembly to center the piston 320, such as rotational motion to piston 320 to improve the gas bearing effect. The flexure bearing 322 may, for example, provide mechanical support for piston 320 while allowing axial motion, with spring characteristics that may contribute to the overall resonant frequency of the resonant system 300. This same resonant relationship may be accomplished using a mechanical spring substituted or in addition to the fluid springs. Alternative bearing configurations may also be employed depending on specific application requirements.

An advantage of using an electromagnetic controller to drive the electromagnetic assembly that is driven under control of the computer is that it may assist in starting the resonant system 300 by driving the piston motion to and at the resonant frequency. The electromagnetic driver may be configured with a control system configured to sense the position of the piston 120 and apply a driving force dependent on the piston position. As a result, the electromagnetic driver may ensure that the piston 120 reaches the desired position on each stroke so that the acoustic valves 101 and 102 are correctly actuated. The electromagnetic stator coil 324 may generate heat as current is passed through it, so the electromagnetic stator coil 324 may be situated near the warm displacement volume 111 such that any heat generated is not transferred to the cold displacement volume 112. Other embodiments may employ a combination of room temperature coils in place of stator coil 324 and, for example, superconducting stator coils located at cold regions of the resonant system 300 for a more efficient driving mechanism.

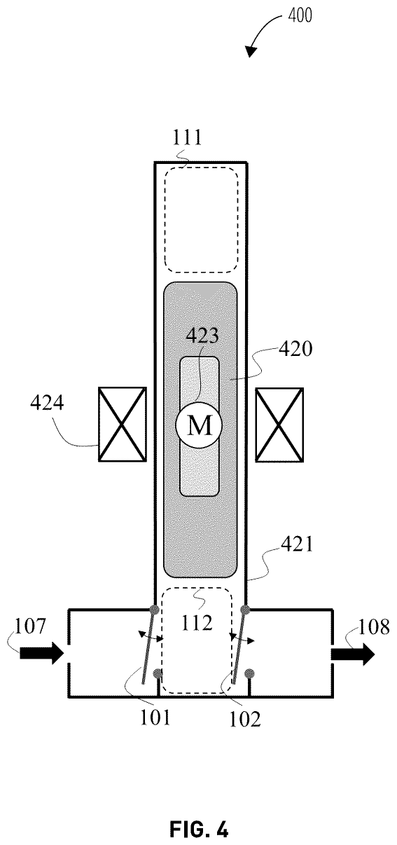

FIG. 4 shows a further embodiment of a resonant expander according to the disclosed subject matter. In FIG. 4, the resonant system 400 includes a piston 420, a magnet assembly 423 and a stator coil 424 may be used as a dissipation mechanism to remove energy from the resonant system 400. Similar to the example of FIG. 3, the magnet assembly 423 may be affixed to the piston 420 to form a magnet-piston assembly. In this example, the motion of the magnet-piston assembly comprising the magnet assembly 423 and piston 420 as it passes through the stator coil 424 induces a current in the stator coil 424 that tends to slow the motion of the piston magnet assembly effectively damping the resonant system. The current that is induced in the electromagnetic stator coil 424 may be recovered to drive, for example, a compressor. Alternatively, the current that is induced in the electromagnetic stator coil 424 can be dissipated as heat in a resistor coupled to a high temperature heat sink. An advantage of the FIG. 4 embodiment is that there are no fluidic connections to the warm displacement volume 112 which make the resonant expander a simpler construction. The expansion chamber 121 can be configured to accommodate the full range of piston motion while maintaining appropriate clearance volumes at both ends. The chamber geometry and piston design may ensure efficient heat transfer and can minimize dead volume effects. The electromagnetic driving system, when present, can provide both energy input during expansion phases and energy dissipation during compression phases to maintain optimal resonant operation. This capability may allow for precise control of system performance across varying operating conditions.

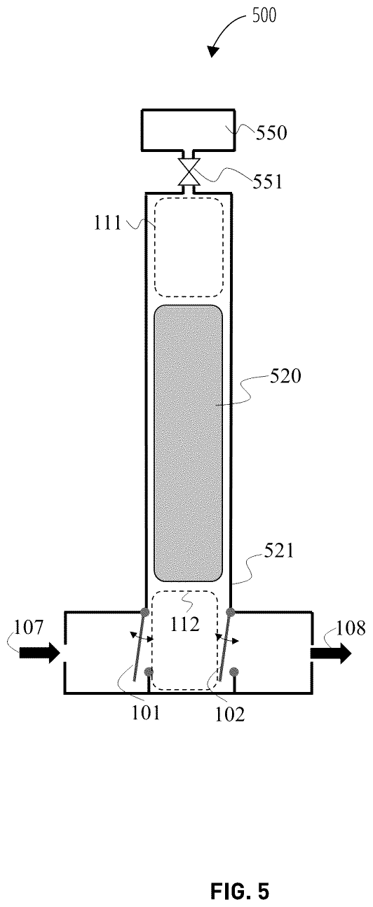

FIG. 5 is another embodiment of a resonant expander. In certain embodiments, a buffer tank, such as 550, may be fluidically coupled to the warm displacement volume 111 by a throttling valve 551 and/or impedance tube coupled to the expansion chamber 521. The buffer tank 550 is configured to provide additional control over system dynamics and energy dissipation characteristics. The buffer tank 550 may be configured to store and release a fluid from the warm displacement volume 111. In an example, as the pressure in the warm displacement volume 111 oscillates, fluid is driven into and out of the buffer tank 550 through the throttling valve 551. As this fluid flow is throttled by the restriction provided by the throttling valve 551, the fluid flow dissipates energy as heat from the resonant system. Although not shown, the throttling valve 551 and buffer tank 550 may be in thermal contact with a heat sink which may be the ambient environment, or the like.

The piston 520 may be configured in a manner similar to pistons described with respect to FIGS. 1-4. In this example, it is configured to have dimensions, mass and diameter that is operable to complement the dissipation mechanism comprising the throttling valve 551 and buffer tank 550.

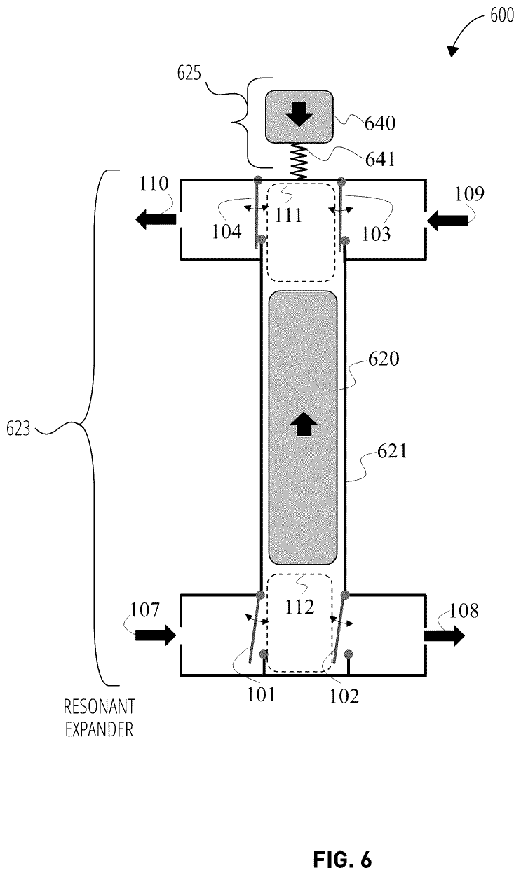

FIG. 6 shows an exemplary spring balancer system, also referred to as a passive balancer, to reduce exported vibrations of a resonant expander. In the example of FIG. 6, the resonant system 600 may include the resonant expander 623 and the balancing system 625. For example, the balancing system 625 may be advantageous to reduce vibrations to minimize noise, reduce failure rate of components, and/or reduce exported vibrations to objects being cooled such as superconducting electronics, or the like. The balancing system 625 may be a spring balancer system that includes a mass 640 and spring 641 to counter act the force created by the motion of the piston 620. The mass 640 and spring 641 of the balancing system 625 may be tuned to have a resonant frequency close to the resonant frequency of the resonant expander 623. For example, the balancer mass 640 may oscillate (e.g., move in opposition (or approximately 180 degrees)) to piston 620 within expansion chamber 621 to cancel the net machine vibration. FIG. 6 shows the balancing system 625 external to the expansion chamber 621, although in other embodiments, the balancing system 625 may be internal to the expansion chamber 621. Other embodiments can include an active balancer system with a damper, an active electromagnetic tuning system or mechanism, or other methods known in the art.

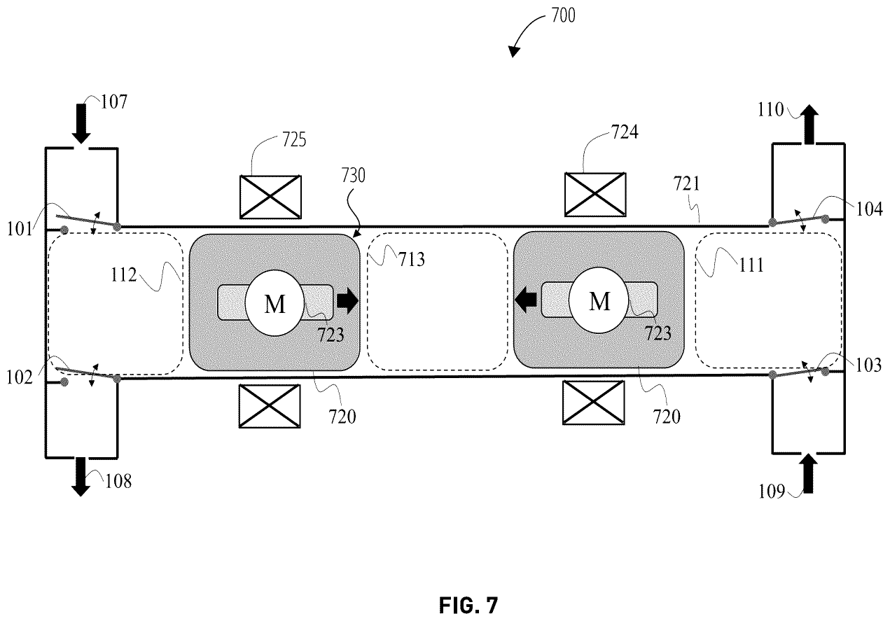

FIG. 7 shows another embodiment of a resonant expander according to the disclosed subject matter. In this embodiment, there are two pistons 720 internal to the expansion chamber 721. An intermediate displacement volume 713 is formed between the two pistons 720. The fluid within the intermediate displacement volume 713 may be coupled to additional fluidic connections at alternative fluid states in a similar manner to the fluidic connections 107-110. The intermediate displacement volume 713 provides an additional fluid spring that contributes to the resonance of the resonant expander 700 in accordance with the principles of the disclosed subject matter. In the FIG. 7 embodiment, each of two pistons 720 are coupled a respective magnet assembly 723. The two pistons 720 with their respective magnet assembly 723 may be electromagnetically driven in tandem in either the same direction or in opposite directions to one another. The control of the magnet assemblies (e.g., stator coils 724 and 725 and magnet assemblies 723 with pistons 720) may implemented as previously described with reference to earlier examples. For example, the stator coils 724 and 725 may be controlled to move the pistons 720 within the expansion chamber 721. Alternatively, the movement of the magnet assemblies 723 within the stator coils 724 and 725 may generate current as described with respect to an earlier example.

This expansion chamber 721 may also be configured with fluidic connections 107-110 as well as additional fluidic connections and/or inlet or outlet ports to provide a fluid state to the intermediate displacement volume 713. The advantages of having additional pistons may be two-fold. A first advantage may be that the pistons 720 may move in opposition to one another, effectively canceling exported vibrations. Another advantage may be an improvement to the power density or efficiency of the resonant expander 700 by a reduction of the leakage flow through the gap 730 space between the pistons 720 and walls of the expansion chamber 721. Further embodiments may use any number of moving pistons in the expansion chamber. In all embodiments of resonant expander 700, the opposing motion of the pistons 720 can achieve the balance effect and/or in combination with methods known in the art.

In an alternative embodiment, the pistons 720 may comprise a plurality of pistons internal to the expansion chamber 721, where each respective piston of the plurality of pistons is adapted for periodic movement within the expansion chamber. Each of the plurality of pistons may be adapted for movement within the expansion chamber 721 while maintaining the resonant system characteristics.

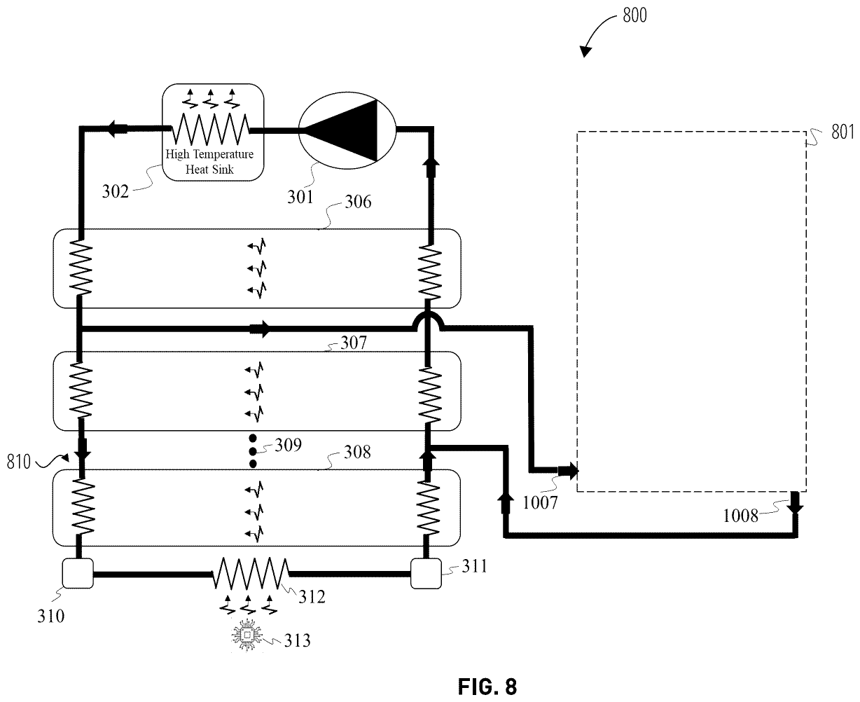

FIG. 8 is one embodiment of a cryogenic cooling system that uses a compressor 301, recuperative heat exchangers 306, 307, 308 and resonant expander 1000. This exemplary cooling system 801 may be used as a low-temperature and/or refrigerator and/or liquefier where the resonant expander can be used to cool the working fluid as part of a refrigeration process. The resonant expander 801, which can be any of the resonant systems or resonant expanders disclosed in the examples of FIGS. 1-7, is operable to cool a fluid to a lower temperature and can be used to affect the fluid expansion. In various system configurations, the low temperature fluid may be used to cool a low temperature heat sink 312, which may comprise a superconducting processor, quantum processor, or a cryo-CMOS processor. The resonant expander 801 may comprise two or more resonant expanders arranged in series or parallel to achieve desired cooling performance. The cryogenic cooling system 800 may be configured such that the cooled fluid is output from an outlet acoustic valve, with the piston being actuated by alternately coupling and decoupling the fluid from the first fluid state and the second fluid state via the inlet acoustic valve and outlet acoustic valve, respectively.

In FIG. 8, the working fluid is compressed from low-pressure to high-pressure by a compressor 301. The heat of compression from the compressor 301 is exhausted to a high-temperature heat sink at a high-temperature heat exchanger 302. Following the high-temperature heat exchanger 302, the high-pressure working fluid can be directed to recuperative heat exchanger 306 where the returning low-pressure fluid pre-cools the high-pressure fluid. This recuperative heat exchanger may be a counterflow heat exchanger or any other type of heat exchanger known in the art. After recuperative heat exchanger 306 a first portion of the high-pressure fluid can be directed to fluidic connection 1007 at the resonant expander 801 while the second portion of the high-pressure fluid can be directed to recuperative heat exchanger 307. The first portion of the high-pressure fluid that was directed to fluidic connection 1007 can be expanded in the resonant expander 1000 to low-pressure and exits at fluidic connection 1008 at a low-temperature and low-pressure. The mechanical energy from this expansion process may be dissipated at a high temperature heat sink (not shown) by any means described in previous embodiments. Alternatively, the mechanical energy from the expansion process can recycled to drive a compression process. The low-pressure and low-temperature working fluid that exits at fluidic connection 1008 may be routed to recuperative heat exchanger 307 to pre-cool the second portion of high-pressure working fluid. In some embodiments, the first portion of high pressure fluid may be about 50% of the total high pressure flow. The specific ratio of first portion flow to second portion flow will depend on the design of the cooling system and may change depending on operating specifications.

At the inlet 810 to recuperative heat exchanger 308, the remaining working fluid at high-pressure is pre-cooled by the remaining working fluid at low-pressure. After recuperative heat exchanger 308, the high-pressure working fluid can be expanded in expansion device 310. Expansion device 310 may be a throttling valve and/or orifice and/or Joule-Thomson valve, or the like. Expansion device 310 may also be an additional resonant expander and/or other expansion device known in the art. This may also be a wet expansion or two-phase expansion process. At the low temperature heat sink 312 and/or a liquefication tank (not shown), the working fluid may be in a multi-phase state of, for example, gas and liquid. After the final expansion stage of expansion device 310, the low temperature fluid is routed to the low temperature heat sink 312. The fluid in the low-temperature low temperature heat sink 312 may also be in a multi-phase state of, for example, gas and liquid. The cold fluid in the low temperature heat sink 312 can be used for refrigeration on a load.

For example, in FIG. 8, the heat load is depicted as a computer processor 313. Alternatively, the liquid in the low temperature heat sink can be removed and stored for use in other applications, such as helium liquefaction, refrigeration of superconducting magnets via liquid coolant, storage of liquid fuel like hydrogen or natural gas, or separation and purification of air. Compression device 311 may also be used in the cycle to compress the saturated vapor to raise the pressure of the low pressure return stream. This can be advantageous in improving overall heat exchanger size and compactness of the system.

Enumeration 309 indicates that this series of recuperative heat exchangers 306, 307, and 308 and resonant expander 801 can be repeated with additional recuperative heat exchangers and additional resonant expansion stages (i.e., resonant expanders). More stages generally allow for a more efficient cooling system that may reach lower temperatures with overall less power consumption.

The working fluid in a low-temperature refrigerator or cryogenic cooling system of the type depicted in FIG. 8 may be helium, air, nitrogen, hydrogen, methane, oxygen, neon, or any other gas and/or combination thereof. The cryogenic cooling system 800 may liquefy these gases by cooling them to low temperature. The purpose may also be to cool the gases to a low temperature for use as a refrigerator for reduced temperature operation, such as in applications of a superconducting computer, quantum computer, superconducting magnet or superconducting electricity transport or any other use case for cryogenic cooling systems.

The working fluid may be selected from various fluid types to optimize performance for specific applications. The fluid that is coupled to the cold displacement volume may be a supercritical fluid, a gas, a liquid, or a two-phase mixture of a gas and liquid, providing flexibility in working fluid selection based on specific application requirements. The fluid that is coupled to the cold displacement volume may be a supercritical fluid, a gas, a liquid, or a two-phase mixture of a gas and liquid, providing flexibility in working fluid selection based on specific application requirements.

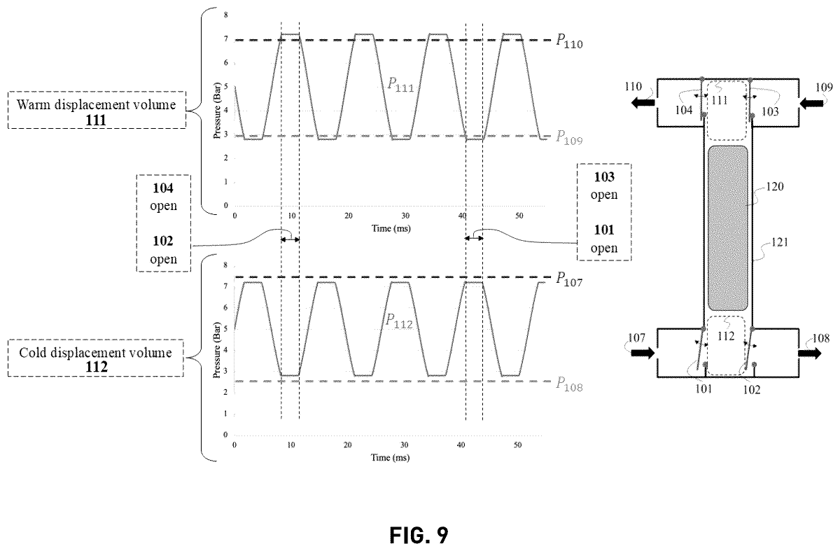

FIG. 9 shows an exemplary depiction of the pressure oscillations with respect to time in a resonant expander as described according to the disclosed subject matter. The exemplary depiction of the pressure oscillations with respect to time is explained with reference to the pressure oscillations in the cold displacement volume 112 and warm displacement volume 111 resonant expander 100 of FIG. 1. The displacement volume pressures are depicted as oscillating nearly sinusoidally at the resonant frequency of the resonant expander. Notice that the oscillating pressures in the displacement volumes are 180 degrees out of phase with each other. In other words, when the pressure rises in the cold displacement volume 112 it falls in warm displacement volume 111 and vice versa.

In this FIG. 9 example, the dissipation mechanism includes check valves 103 and 104 on the warm displacement volume 111, as shown in FIG. 1 and re-shown in FIG. 9. FIG. 9 also indicates when each of the acoustic valves 101 and 102 are open and when the check valves 103 and 104 are open. The pressure at fluidic connections 107, 108, 109, and 110 are also marked and are assumed to be constant with respect to time.

In this example the fluid pressure at fluidic connection 107 is 7.5 Bar and the pressure at fluidic connection 108 is 2.5 Bar. The pressure in the cold displacement volume 112 oscillates just between the pressures at fluidic connections 107 and 108. When the pressure in the cold displacement volume 112 nears the pressure at fluidic connection 107, the inlet acoustic valve 101 opens allowing fluid to enter the cold displacement volume 112 at a high pressure. This fluid coupling from acoustic valve 101 effectively adds energy to the resonant system and drives the piston motion. When the pressure in the cold displacement volume 112 nears the pressure at fluidic connection 108, the outlet acoustic valve 102 opens allowing fluid to exit the cold displacement volume 112 at a low pressure. This fluid coupling from acoustic valve 102 effectively adds energy to the resonant system and drives the motion of the piston 120.

In this example, the fluid pressure at fluidic connection 109 is, for example, 3 Bar and the pressure at fluidic connection 110 is, for example, 7 Bar. The pressure in the warm displacement volume 111 oscillates just beyond the pressures at fluidic connections 109 and 110. When the pressure in the warm displacement volume 111 rises just above the pressure at fluidic connection 110, the check valve 104 opens allowing fluid to exit the warm displacement volume 111 at a high pressure. This fluid coupling from check valve 104 effectively removes energy from the resonant system and damps the piston motion. When the pressure in the warm displacement volume 111 falls just below the pressure at fluidic connection 109, the check valve 103 opens allowing fluid to enter the warm displacement at a low pressure. This fluid coupling from check valve 103 effectively removes energy from the resonant system and damps the piston motion.

It should be noted that the pressures listed and valve operation described is exemplary. The operation of the valves and resonant expander is cyclical. In some designs, the pressures at fluidic connections 107, 108, 109 and 110 may not be constant with respect to time. Similarly, the pressure oscillations in the displacement volumes may not approximate sinusoidal oscillation and may include other harmonics. Furthermore, the amplitude of pressure oscillations in 111, 112, and possibly 113, can be raised or lowered by adjusting the mean piston oscillation position such that a larger or smaller portion of the displacement volume is swept for a given stroke of the piston.

FIG. 10 is an exemplary depiction of an acoustic valve operating principle. The schematics labeled FIG. 10 (i)-(iii) depicts an acoustic valve which, in this embodiment, is a poppet disk fixed to a spring. FIG. 10 (i) shows that this acoustic valve has an equilibrium position that is open. The poppet is not in contact with the seat in FIG. 10 (i). The FIG. 1-9 embodiments depict the acoustic valve as a reed. In the case of the reed acoustic valve, the spring-like behavior is provided by the reed itself.

On one side of the acoustic valve is a fluid source at pressure, Pᵢₙ, that drives fluid flow, \dot{V}, to the other side of the acoustic valve which is at a pressure Pₒᵤₜ. The pressure difference that drives the fluid flow is referred to as ΔP=Pᵢₙ−Pₒᵤₜ. The plot shows the volumetric flow rate, \dot{V}, through the acoustic valve as a function of the pressure difference across the valve.

FIG. 10 shows that when the pressure difference across the acoustic valve is zero, there is zero volumetric flow rate through the acoustic valve. As the pressure difference across the acoustic valve increases, flow is driven through the acoustic valve by the pressure difference. However, since the acoustic valve is a spring-like member the pressure difference also causes the valve to become displaced towards closure. In other words, the pressure difference has two primary effects: The first effect is that the pressure difference drives volumetric flow and the second effect is that the pressure difference displaces the valves towards a closed position. As the pressure difference increases, the first effect increases the flow rate. As the pressure difference increases, the second effect decreases the flow rate. Consequently, there will be a point of maximum flow rate, \dot{V}ₘₐₓ, through the acoustic valve depicted by FIG. 10 (ii). As the pressure difference is increased further, the acoustic valve eventually becomes completely shut as depicted in FIG. 10 (iii) resulting in zero flow rate through the acoustic valve. Once the valve is closed, increasing the pressure difference further results in zero flow rate though the acoustic valve. The pressure difference at which the acoustic valve is closed is referred to as ΔPₘₐₓ.

The negative resistance characteristic of an acoustic valve depends on the exact geometrical arrangement of the valve, valve spring stiffness, and valve mass. The design of the resonant expander determines the preferred acoustic valve characteristic. As shown in FIGS. 10 and 11, the acoustic valve negative resistance characteristic may have a steeper slope or more gradual slope. Steeper slopes may be preferred to ensure rapid closing of the acoustic valve. Furthermore, the magnitude of the acoustic valve closing pressure, ΔPₘₐₓ, depends on acoustic valve stiffness. Resonant expanders that are designed for large operating pressures may prefer to use an acoustic valve with a larger ΔPₘₐₓ. For example, if the resonant expander is designed with an inlet pressure of 10 bar and an outlet pressure of 1 bar, the acoustic valve closing pressure, ΔPₘₐₓ may be approximately 0.5 Bar. Similarly, the value of the maximum volumetric flow rate through the acoustic valve, \dot{V}ₘₐₓ, will depend on the design of the resonant expander. If the average flow rate through the resonant expander is approximately 100 standard liters per minute, then the acoustic valve should have a maximum flow rate that is around 500 standard liters per minute.

Therefore, a characteristic of the acoustic valve is a region of negative flow resistance, wherein an increasing pressure differential across the acoustic valve results in a decrease to the flow rate through the valve.

The time constant of the acoustic valve may also be important to the design of a resonant expander. The time constant relating to how quickly the acoustic valve can open and close. The time constant depends on the effective mass of the acoustic valve and the spring stiffness of the acoustic valve. In most embodiments of the resonant expander, the time constant of the acoustic valve should be two to five times greater than the time constant of the resonant expander. For example, if the resonant expander time constant is 20 milli-seconds (corresponding to a resonant frequency of 50 Hz), then the acoustic valve time constant may be somewhere between 2 to 10 milli-seconds. In other embodiments, it may be preferable to match the time constant of the acoustic valve to the time constant of the resonant expander.

While the acoustic valve is depicted as a poppet mounted to a spring-like member in FIG. 10, there are many other embodiments that exhibit the defining negative resistance characteristic. For example, a reed valve, flexure spring valve or other valve with a spring like characteristic that is normally open under zero pressure differential. The resonant expander and systems of the present disclosed subject matter can be operated with any type of acoustic valve that exhibits a negative flow resistance like that described by the FIG. 10 embodiment. The negative flow resistance allows the valves to be passively actuated by the oscillating pressures in the resonant expander. It may also be advantageous to modify or augment the valve motion with electromagnetic control for semi-passive operation. Of course, acoustic valves exhibiting other negative flow resistance curves may also be used with the resonant expander and systems described herein.

FIG. 11 is an exemplary depiction of an acoustic valve operating principle. The schematics labeled FIG. 11 (i)-(iii) depicts an acoustic valve which is a thin strip of material (usually metal) that is clamped at one end and free on the opposite end. This reed acoustic valve has a spring-like behavior such that its equilibrium position is open. FIG. 11 (i) shows that this acoustic valve has an equilibrium position that is open. On one side of the acoustic valve is a fluid state at pressure, Pᵢₙ, that drives fluid flow, \dot{V}, to the other side of the acoustic valve which is at a pressure Pₒᵤₜ. The pressure difference that drives the fluid flow is referred to as ΔP=Pᵢₙ−Pₒᵤₜ. The plot shows the volumetric flow rate, \dot{V}, through the acoustic valve as a function of the pressure difference across the valve.

FIG. 11 shows that when the pressure difference across the acoustic valve is zero, there is zero volumetric flow rate through the acoustic valve. As the pressure difference across the acoustic valve increases, flow is driven through the acoustic valve by the pressure difference. However, since the acoustic valve is a spring-like member the pressure difference also causes the valve to become displaced towards closure. In other words, the pressure difference has two primary effects: The first effect is that the pressure difference drives volumetric flow and the second effect is that the pressure difference displaces the valves towards a closed position. As the pressure difference increases, the first effect increases the flow rate. As the pressure difference increases, the second effect decreases the flow rate. Consequently, there will be a point of maximum flow rate, \dot{V}ₘₐₓ, through the acoustic valve depicted by FIG. 11 (ii). As the pressure difference is increased further, the acoustic valve eventually becomes completely shut as depicted in FIG. 11 (iii) resulting in zero flow rate through the acoustic valve. Once the valve is closed, increasing the pressure difference further results in zero flow rate though the acoustic valve. The pressure difference at which the acoustic valve is closed is referred to as ΔPₘₐₓ.

Therefore, the defining characteristic of the acoustic valve is a region of negative flow resistance, wherein an increasing pressure differential across the acoustic valve results in a decrease to the flow rate through the valve.

While the acoustic valve is depicted as a reed-valve in FIG. 11, there are many other embodiments that exhibit the defining negative resistance characteristic. For example, a flexure spring valve or a poppet valve with a spring member. The resonant expander of the present disclosed subject matter can be operated with any type of acoustic valve that exhibits a negative flow resistance like that described by the FIG. 11 embodiment. Of course, acoustic valves exhibiting other negative flow resistance curves may also be used with the resonant expander and systems described herein.

The negative resistance characteristic of an acoustic valve depends on the exact geometrical arrangement of the valve, valve spring stiffness, and valve mass. The design of the resonant expander determines the preferred acoustic valve characteristic. As shown in FIGS. 10 and 11, the acoustic valve negative resistance characteristic may have a steeper slope or more gradual slope. Steeper slopes may be preferred to ensure rapid closing of the acoustic valve. Furthermore, the magnitude of the acoustic valve closing pressure, ΔPₘₐₓ, depends on acoustic valve stiffness. Resonant expanders that are designed for large operating pressures may prefer to use an acoustic valve with a larger ΔPₘₐₓ. For example, if the resonant expander is designed with an inlet pressure of 10 bar and an outlet pressure of 1 bar, the acoustic valve closing pressure, ΔPₘₐₓ may be approximately 0.5 Bar. Similarly, the value of the maximum volumetric flow rate through the acoustic valve, \dot{V}ₘₐₓ, will depend on the design of the resonant expander. If the flow rate through the resonant expander is approximately 100 standard liters per minute, then the acoustic valve should have a maximum flow rate that is around 500 standard liters per minute.

The time constant of the acoustic valve may also be important to the design of a resonant expander. The time constant relating to how quickly the acoustic valve can open and close. The time constant depends on the effective mass of the acoustic valve and the spring stiffness of the acoustic valve. In most embodiments of the resonant expander, the time constant of the acoustic valve should be two to five times greater than the time constant of the resonant expander. For example, if the resonant expander time constant is 20 milli-seconds (corresponding to a resonant frequency of 50 Hz), then the acoustic valve time constant may be somewhere between 2 to 10 milli-seconds. In other embodiments, it may be preferable to match the time constant of the acoustic valve to the time constant of the resonant expander.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims.

Exemplary embodiments may include, but are not limited to Example 1: A resonant expander, comprising: an expansion chamber; a piston adapted for periodic movement within said expansion chamber, the piston being free from solid contact with a drive mechanism that is external to the expansion chamber, wherein: the piston has a range of motion extending between a cold displacement volume disposed at one end of the expansion chamber and a warm displacement volume disposed at another end of the expansion chamber, the piston and fluid within the warm displacement volume and fluid within the cold displacement volume create a resonant system at a resonant frequency of the resonant expander, and the cold displacement volume is fluidically coupled to an inlet port and an outlet port, wherein the piston motion is actuated by alternately coupling and decoupling fluid through the inlet port and outlet port of the cold displacement volume, the inlet port to the cold displacement volume are coupled to a first fluid state. The outlet port from the cold displacement space are coupled to a second fluid state

Example 2: The resonant expander of example 1, further comprising: a dissipation mechanism to remove energy from the resonant expander.

Example 3: The resonant expander of example 1, further comprising: a valve disposed at the inlet port of the cold displacement volume, wherein the valve is configured to oscillate between an open state and closed state to allow fluid from the first fluid state to enter the cold displacement volume.

Example 4: The resonant expander of example 3, further comprising: a valve disposed at the outlet port of the cold displacement volume that is configured to oscillate between an open state and closed state to allow fluid to exit the cold displacement volume to the second fluid state.

Example 5: The resonant expander of example 1, wherein the dissipation mechanism is a fluidic coupling to the warm displacement volume with an inlet port and an outlet port, wherein the inlet port to the warm displacement volume is coupled to a fluidic connection at a third fluid state and the outlet port is coupled to a fluidic connection at a fourth fluid state.

Example 6: The resonant expander of example 5, further comprising: a valve disposed at the inlet port of the dissipation mechanism, wherein the inlet port of the dissipation mechanism is configured to oscillate between an open state and closed state to allow fluid to enter the warm displacement volume at a third pressure and third temperature.

Example 7: The resonant expander of example 5, further comprising: a valve disposed at the outlet port of the dissipation mechanism, wherein the outlet port of the dissipation mechanism is configured to oscillate between an open state and closed state to allow fluid to exit the warm displacement volume at a fourth pressure and fourth temperature.

Example 8: The resonant expander of example 1, wherein the piston is a parcel of fluid.

Example 9: The resonant expander of example 1, wherein the piston is substantially incompressible.

Example 10: The resonant expander of example 1, wherein the piston is supported and aligned by a spring or flexure spring.

Example 11: The resonant expander of example 1, wherein the piston is externally driven electromagnetically.

Example 12: The resonant expander of example 11, wherein a magnet assembly is rigidly fixed to the piston to form a magnet-piston assembly, and a stator coil is positioned to inductively drive the magnet-piston assembly.

Example 13: The resonant expander of example 3, wherein the valve disposed at the inlet port of the cold displacement volume is an acoustic valve that has a negative flow characteristic, and is a first valve.

Example 14: The resonant expander of example 13, wherein acoustic valve is configured to oscillate passively and/or semi-passively.

Example 15: The resonant expander of example 4, wherein the valve disposed at the outlet port of the cold displacement volume is an acoustic valve that has a negative flow characteristic, and is a second valve.

Example 16: The resonant expander of example 15, wherein the acoustic valve is configured to oscillate passively and/or semi-passively.

Example 17: The resonant expander of example 6, wherein the valve disposed at the inlet port to the warm displacement volume is a one-way check valve.

Example 18: The resonant expander of example 7, wherein the valve disposed at the outlet port to the warm displacement volume of is a one-way check valve.

Example 19: The resonant expander of example 1, further comprising: a balancing system comprising a mass oscillates in opposition to the motion of the piston canceling vibration thereof.

Example 20: The resonant expander of example 1, wherein the piston is a plurality of pistons internal to the expansion chamber, and each respective piston of the plurality of pistons is adapted for periodic movement within said expansion chamber.

Example 21: The resonant expander of example 1 wherein the fluid that is coupled to the cold displacement volume is a supercritical fluid, a gas, a liquid, a two-phase mixture of a gas and liquid.

Example 22: The electromagnetic driver of example 12, further comprising: a computer operable to control the position of the magnet-piston assembly.

Example 23: A system for providing a low temperature fluid, said system comprising: a compressor; a recuperative heat exchanger disposed in fluid communication with said compressor; a resonant expander disposed in fluid communication with said heat exchanger, wherein the resonant expander includes: an inlet acoustic valve that fluidically couples a first fluidic connection to a cold displacement volume of the resonant expander; and an outlet acoustic valve that fluidically couples a second fluidic connection to a cold displacement volume.

Example 24: A resonant expander for cooling a fluid, comprising: an expansion chamber; a piston adapted for periodic movement within the expansion chamber, wherein the piston has a range of motion extending between a cold displacement volume disposed at one end of the expansion chamber and a warm displacement volume disposed at the other end of the expansion chamber; a first fluidic connection from a first fluid state; a second fluidic connection from a second fluid state; an inlet acoustic valve that fluidically couples the first fluidic connection to the cold displacement volume; and an outlet acoustic valve that fluidically couples the second fluidic connection to the cold displacement volume, wherein the piston, a fluid within the warm displacement volume, and a fluid within the cold displacement volume create a resonant system at the resonant frequency of the expander, and the piston is actuated by alternately coupling and decoupling the fluid from the first fluidic connection and the second fluidic connection via the inlet acoustic valve and outlet acoustic valve, respectively, and the cooled fluid is output from outlet acoustic valve.

Example 25: The resonant expander of example 24 wherein a third fluid state is coupled to the warm displacement volume by a third fluidic connection.

Example 26: The resonant expander of example 24, further comprising: a valve disposed at the inlet port of the cold displacement volume, wherein the valve is configured to oscillate between an open state and closed state to allow fluid to enter the warm displacement volume at a third pressure and third temperature.

Example 27: The resonant expander of example 24 wherein a fourth fluid state is coupled to the warm displacement volume by a fourth fluidic connection.

Example 28: The resonant expander of example 27, further comprising: a valve disposed at the fourth fluid connection wherein the valve is configured to oscillate between an open state and a closed state to allow fluid to exit the warm displacement volume at a fourth pressure and fourth temperature.

Example 29: The resonant expander of example 24, wherein the piston is a substantially compressible parcel of fluid.

Example 30: The resonant expander of example 24, wherein the piston is a substantially incompressible solid body.

Example 31: The resonant expander of example 24, wherein the piston is supported and aligned by a spring or flexure spring.

Example 32: The resonant expander of example 24, wherein the motion of the piston within the range of motion is driven electromagnetically and/or damped electromagnetically.

Example 33: The resonant expander of example 32, wherein a magnet assembly is rigidly fixed to the piston and a coil is positioned to inductively add energy to the magnet-piston assembly, and the added energy is operable electromagnetically drive the magnet-piston assembly within the range of motion of the piston.

Example 34: The resonant expander of example 32, wherein a magnet assembly is rigidly fixed to the piston and a coil is positioned to inductively dissipate energy from the magnet-piston assembly and the dissipated energy is operable electromagnetically limit motion of the magnet-piston assembly within the range of motion of the piston.

Example 35: The resonant expander of example 24, wherein the inlet acoustic valve and the outlet acoustic valve each have an equilibrium position which is open and exhibit a negative flow characteristic.

Example 36: The resonant expander of example 24, wherein the inlet acoustic valve and the outlet acoustic are respectively configured to oscillate passively and/or semi-passively.

Example 37: The resonant expander of example 25, wherein the valve disposed at the third fluidic connection to the warm displacement volume is a one-way check valve.

Example 38: The resonant expander of example 28, wherein the valve disposed at the fourth fluidic connection to the warm displacement volume is a one-way check valve.

Example 39: The resonant expander of example 24 wherein an oscillating balancer mass and balancer spring move in opposition to the motion of the piston canceling vibration thereof.

Example 40: The resonant expander of example 24, wherein the piston is a plurality of pistons internal to the expansion chamber, and each of the plurality of pistons is adapted for movement within the expansion chamber.

Example 41: The of example 24 wherein the fluid that is coupled to the cold displacement volumes.

Example 42: The resonant expander of example 33, further comprising: a computer configured to control the electromagnetic driving and/or electromagnetic damping of the magnet-piston assembly.

Example 43: The resonant expander of example 24, wherein a buffer tank is fluidically coupled to the warm displacement volume by a throttling valve and/or impedance tube.

Example 44: A system for providing a low temperature fluid, the system comprising: a compressor; a recuperative heat exchanger disposed in fluid communication with the compressor; and a resonant expander disposed in fluid communication with the heat exchanger.

Example 45: The system of example 44, wherein the low temperature fluid is used to cool a low temperature heat sink.

Example 46: The system of example 45, wherein the low temperature heat sink is a superconducting processor, quantum processor, or a cryo-CMOS processor.

Example 47: The system of example 44, wherein the resonant expander comprises: two or more resonant expanders arranged in series or parallel.

Example 48: A system for providing a low temperature fluid, said system comprising: a compressor; a recuperative heat exchanger disposed in fluid communication with said compressor; a resonant expander disposed in fluid communication with said heat exchanger; and a dissipation mechanism to remove energy from the resonant expander.

Some embodiments and/or examples, may be described using the expression “one embodiment” or “an embodiment” or “one example” or “an example” along with their derivatives. These terms mean that a particular feature, structure, or characteristic described in connection with the embodiment is included in at least one embodiment or example. The appearances of the phrase “in one embodiment” or “in one example” in various places in the specification are not necessarily all referring to the same embodiment or example. Moreover, unless otherwise noted the features described above are recognized to be usable together in any combination. Thus, any features discussed separately may be employed in combination with each other unless it is noted that the features are incompatible with each other.

While this specification contains many specific implementation details, these should not be construed as limitations on the scope of any disclosed subject matters or of what may be claimed, but rather as descriptions of features specific to particular implementations of particular disclosed subject matters. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations may be depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described components and systems can generally be integrated together in a single product or packaged into multiple products.

Each numerical value presented herein is contemplated to represent a minimum value or a maximum value in a range for a corresponding parameter. Accordingly, when added to the claims, the numerical value provides express support for claiming the range, which may lie above or below the numerical value, in accordance with the teachings herein. Every value between the minimum value and the maximum value within each numerical range presented herein (including in the figures), is contemplated and expressly supported herein, subject to the number of significant digits expressed in each particular range. Absent express inclusion in the claims, each numerical value presented herein is not to be considered limiting in any regard.

Unless expressly described elsewhere in this application, as used herein, when the term “substantially” or “about” is before a quantitative value, the present disclosure also includes the specific quantitative value itself, as well as, in various cases, a ±1%, ±2%, ±5%, and/or ±10% variation from the nominal value unless otherwise indicated or inferred.

Some embodiments or examples may be described using the expression “coupled” and “connected” along with their derivatives. These terms are not necessarily intended as synonyms for each other. For example, some embodiments or examples may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment or example for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment or example. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

Having described herein illustrative embodiments, persons of ordinary skill in the art will appreciate various other features and advantages of the disclosed subject matter apart from those specifically described above. It should therefore be understood that the foregoing is only illustrative of the principles of the disclosed subject matter, and that various modifications and additions, as well as all combinations and permutations of the various elements and components recited herein, can be made by those skilled in the art without departing from the spirit and scope of the disclosed subject matter. Accordingly, the appended claims shall not be limited by the particular features that have been shown and described, but shall be construed also to cover any obvious modifications and equivalents thereof.

What is claimed is:

1. A resonant expander for cooling a fluid, comprising:
an expansion chamber;
a piston adapted for periodic movement within said expansion chamber, the piston being free from solid contact with a mechanism that is external to the expansion chamber, the piston has a range of motion extending between a cold displacement volume disposed at one end of the expansion chamber and a warm displacement volume disposed at another end of the expansion chamber,
a first fluidic connection from a first fluid state;
a second fluidic connection from a second fluid state;
an inlet acoustic valve that fluidically couples the first fluidic connection to the cold displacement volume; and
an outlet acoustic valve that fluidically couples the second fluidic connection to the cold displacement volume,
wherein the piston, and/or fluid within the warm displacement volume, and/or a fluid within the cold displacement volume create a resonant system substantially at the operating frequency of the expander, and the periodic movement of the piston is maintained by coupling and decoupling the fluid from the first fluidic connection and the second fluidic connection via the inlet acoustic valve and outlet acoustic valve, respectively, and the cooled fluid is output from the second fluidic connection.

2. The resonant expander of claim 1 wherein a third fluidic connection is coupled to the warm displacement volume from a third fluid state.

3. The resonant expander of claim 2, further comprising:
a valve disposed at the warm displacement volume wherein the valve is configured to oscillate between an open state and a closed state to allow fluid to exit the warm displacement volume to the third fluidic connection.

4. The resonant expander of claim 1 wherein a fourth fluidic connection is coupled to the warm displacement volume from a fourth fluid state.

5. The resonant expander of claim 4, further comprising:
a valve disposed at the warm displacement volume wherein the valve is configured to oscillate between an open state and a closed state to allow fluid to exit the warm displacement volume to the fourth fluidic connection.

6. The resonant expander of claim 1, wherein the piston is a substantially compressible parcel of fluid.

7. The resonant expander of claim 1, wherein the piston is a substantially incompressible solid body.

8. The resonant expander of claim 1, wherein the piston is supported and aligned by a spring or flexure spring.

9. The resonant expander of claim 1, wherein the motion of the piston, within the range of motion, is driven electromagnetically and/or damped electromagnetically.

10. The resonant expander of claim 9, wherein a magnet assembly is rigidly fixed to the piston and a stator coil is positioned to inductively add energy to the magnet-piston assembly, and the added energy electromagnetically drives the magnet-piston assembly within the range of motion of the piston.

11. The resonant expander of claim 9, wherein a magnet assembly is rigidly fixed to the piston and a stator coil is positioned to inductively dissipate energy from the magnet-piston assembly and the dissipated energy electromagnetically limits the motion of the magnet-piston assembly within the range of motion of the piston.

12. The resonant expander of claim 1, wherein the inlet acoustic valve and the outlet acoustic valve each have an equilibrium position which is open and exhibit a negative flow characteristic.

13. The resonant expander of claim 1, wherein the inlet acoustic valve and the outlet acoustic are respectively configured to oscillate passively and/or semi-passively.

14. The resonant expander of claim 2, wherein the valve disposed at the warm displacement volume to the third fluidic connection is a one-way check valve.

15. The resonant expander of claim 3, wherein the valve disposed at the warm displacement volume to the fourth fluidic connection is a one-way check valve.

16. The resonant expander of claim 1 wherein an oscillating balancer mass and balancer spring move in opposition to the motion of the piston canceling vibration thereof.

17. The resonant expander of claim 1, wherein the piston is a plurality of pistons internal to the expansion chamber, and each of the plurality of pistons is adapted for movement within the expansion chamber.

18. The resonant expander of claim 1 wherein the fluid that is coupled to the cold displacement volume and warm displacement volume is a supercritical fluid, and/or a gas, and/or a liquid, and/or a two-phase mixture of a gas and liquid, and/or a multi-phase mixture of a gas and liquid and solid.

19. The resonant expander of claim 9, further comprising:
a computer configured to control the electromagnetic driving and/or electromagnetic damping of the magnet-piston assembly.

20. The resonant expander of claim 1, wherein a buffer tank is fluidically coupled to the warm displacement volume by a throttling valve and/or impedance tube.

21. A system for providing a low temperature fluid, the system comprising:
a compressor;
a recuperative heat exchanger disposed in fluid communication with the compressor;
a resonant expander utilizing acoustic valves disposed in fluid communication with the heat exchanger, wherein the resonant expander includes:
an inlet acoustic valve that fluidically couples a first fluidic connection to a cold displacement volume of the resonant expander; and
an outlet acoustic valve that fluidically couples a second fluidic connection to a cold displacement volume.

22. The system of claim 21, wherein the low temperature fluid is used to cool a low temperature heat sink that is thermally coupled to a superconducting processor, quantum processor, or a cryo-CMOS processor.

23. The system of claim 21, wherein the resonant expander comprises: two or more resonant expanders arranged in series or parallel.

24. A resonant expander for cooling a fluid, comprising:
an expansion chamber;
a piston adapted for periodic movement within said expansion chamber, the piston being free from solid contact with a mechanism that is external to the expansion chamber, the piston has a range of motion extending between a cold displacement volume disposed at one end of the expansion chamber and a warm displacement volume disposed at another end of the expansion chamber,
an electromagnetic system comprised of a permanent magnet fixed to said piston, a stator assembly fixed to said expansion chamber and a controller to control operation of said piston motion;
a first fluidic connection from a first fluid state;
a second fluidic connection from a second fluid state;
an inlet acoustic valve that fluidically couples the first fluidic connection to the cold displacement volume; and
an outlet acoustic valve that fluidically couples the second fluidic connection to the cold displacement volume,
wherein the piston-magnet assembly, and/or fluid within the warm displacement volume, and/or fluid within the cold displacement volume, and/or the stator assembly create a resonant system substantially at the operating frequency of the expander, and the periodic movement of the piston is maintained by the coupling and decoupling the fluid from the first fluidic connection and the second fluidic connection via the inlet acoustic valve and outlet acoustic valve, respectively, and the periodic movement of the piston is maintained by the electromagnetic system.
